(19) United States
(12) Patent Application Publication
(10) Pub. No.: US 2008/0147548 A1
(43) Pub. Date: Jun. 19, 2008

(54) Online third party payment system as a guarantor for business transaction safety

(76) Inventor: Lixian Jiang, Land O Lakes, FL (US)

Correspondence Address: Lixian Jiang, 2102 Camp Indianhead Road, Land O Lakes, FL, 34639, US

(21) Appl. No.: 11/638,068

(22) Filed: Dec. 13, 2006

(51) Int. Cl. G06Q 20/00; G06Q 40/00

(52) U.S. Cl. 705/44; 705/35

(57) ABSTRACT

An online third party payment system is for business transaction, where the system functions as a guaranty between the seller and the buyer. The buyer pays money to the said system, and the money will not be released to any party until the business transaction is fulfilled. The said system guarantees the safety of the business transaction.

### FIELD OF THE INVENTION

The present invention is in the field of an online third party payment system, where the system has a guaranty for buyers that the service/products will be received, and a guaranty for sellers that money will be reimbursed.

### BACKGROUND OF THE INVENTION

With internet and telecommunication development, more and more people do business online. This trend brings up a question of business safety, which is if the seller can get the money after shipping out the products, and if the buyer can get the product after paying money. Even in USA, some people shop on internet, and can not get anything from seller. This becomes worse for international business.

To solve this problem, people use “letter of credit” for international business. This works pretty well, and greatly reduces business risk. However, the whole process involves seller's bank, buyer's bank, carrier, contract and many other documents. It is not convenient. This process is also money cost, and for some small business transaction between individuals the process costs more than the value of the products. In addition, letter of credit usually for international business. It does not reduce the risk of domestic business.

There are other online payment systems such as “Verisign, Inc” credit card processing system, “Paypal, Inc” third party payment system. Most of them are based on SSL internet certificate and/or third party payment. The SSL certificate is 128-bit or 256-bit encryption in the payment gateway, which make sure that no other visitor can steal the financial data when processing the credit card or any other financial information through this gateway. The third party payment system is to use the third party secured payment system for money transfer, which will not give any credit card or financial information to seller. Thus, it increases the security. These systems are very convenient for customers shop online, and they have successfully solved the security problem of money transaction. This means the financial data is secured and will not bleach to any other party. However, this just makes sure the money can safely be transferred to the person suppose to send to. This does not guarantee that the business transaction is safe that the buyer can get the product or service after the payment. In another word, the money transaction is safe, but the business transaction may not.

The current invention disclosures an online payment system, which will guarantee the safety of business transaction as well as money transaction. Briefly, the buyer pays the money online to the third party payment system other than seller. This system is secured with SSL certificate or any other secured software encryptions, which ensure that the financial information will not be bleached by any visitors. The system then informs the seller that the money is ready and the seller should provide service or products within certain time. The money will be hold until the service or products are fulfilled by the confirmation of buyer or other evidences.

In another embodiment, if the products or services are not consistent with the description in the business contract, the buyer can login in online within certain time to claim, and send back the services/products to seller. The buyer can get money back after pay some small fee unless the services or products are returned to seller. The returned service or products should be confirmed by the seller or other evidences such as shipment receipt, or the system automatically confirms that the services/products have been returned if the seller dose not confirm within certain time.

In another embodiment, if the products or services are not shipped, the buyer complaints online. The information will be sent to seller. If the seller can not provide evidences to show the services/products are shipped, the money is refunded to buyer. If the delivery is confirmed, the time is extended to allow the business fulfilled.

### SUMMARY OF THE INVENTION

This current invention discloses an online third party payment system, where the payment is paid to the third party, “the system”, instead of the seller. The system will hold the money until the business transaction is fulfilled. Otherwise, the money will return to the buyer after certain fee.

In one embodiment, the payment system comprises of an online payment processing unit. This unit comprises of 128-bit or 256-bit SSL encryption or any other secured encryption to secure money to transfer to the system. In another embodiment, the system comprises of a buyer unit, which allows the buyer to confirm the services or products are received. This unit also allows the buyer to complaint the services or products.

In another embodiment, the system comprises of a seller unit, which allows the payment system to inform the seller that the money is ready and he should provide his services or products. This unit is also for seller to confirm receiving the returned service or products. In another embodiment, the said system also comprises of data processing center to analyze the data received from the said three units.

The data flows in the following direction. Briefly, the buyers input the payment information at the buyer unit, and the payment information is transmitted to online payment processing unit, where the payment is verified. The verified information as well as other information is sent to the data processing center, where the data is stored and it is further sent to seller unit to inform the seller that the money is ready and he should perform his obligation. At this stage, the money is hold, and no money is released to seller or buyer. The seller provides service or products to the buyer within certain time which was set by buyer when he first input the information at the buyer unit according to their agreement. The services or products are shipped to buyers. The buyer confirms the fulfillment of this business or if the buyers do not confirm within the certain time, the money is released to seller by the payment system automatically. If the buyers are not satisfied with the services or products, they claim at the buyer unit. The money will continue to be hold until the sellers confirm that the services or products are returned or until sellers do not confirm within certain time. In this case, the money will return to buyer. Otherwise, the money will be released to seller.

In another embodiment, if the buyer dose not get the services/products, the buyer login in the buyer unit and complaint. This information will be sent to the seller. If the seller can not provide any shipping evidences, such as shipping track number, the buyer will get refund. Otherwise, the time frame is extended to allow the business fulfilled.

### DETAILED DESCRIPTION OF THE INVENTION

The current invention disclosures a third party online payment processing system, where the system involves in the examination of the real of business transaction, and the money is hold by the system until the business transaction is confirmed.

In one embodiment, the system comprises of an online payment processing unit. This unit comprises of 128-bit or 256-bit SSL encryption or any other secured encryption to secure money to transfer to the system. The system also comprises of a data processing center for data processing and analysis purpose. In another embodiment, the system comprises of a buyer unit for buyer confirm the services or products are received or provide other information. This unit is also used for complaint of the service or products received by buyer. In another embodiment, the system has a seller unit. The seller unit will inform the seller that the money is ready and the seller should provide service. The seller unit also provides a platform for seller to confirm the returned services/products or provide other information.

For a serious business transaction, the seller and buyer already contacted each other and made a deal before using this payment system. The buyer should already get the contact information of seller's which includes email or phone number. The buyer goes to the payment web site, where it is buyer unit. The buyer inputs payment information as well as seller and buyer's email, shipping address, other contact information and the time frame of shipping. The time is very important as to determine if the agreement is fulfilled or not, and it also determines when the money should be released, and which party the money should be released to. The email of both parties is mandatory. As an option, each party's contact may be input by the party himself. The financial data are sent to online payment processing unit. The online payment processing unit validates the financial information, and sends all data to the data processing center. Simultaneously, all other data also are sent to the data processing center, where the data are stored and analyzed. The system collects money from buyer through the online payment processing unit under the third party name.

The data processing center gets all the data, and generates a password with a “seller unit” link to seller through email, maybe through mobile phone by text message as well. Simultaneously it informs seller that the money is ready, and he should provide services or products within certain time. At this stage, the money is hold by the system, and no one can retrieve money from system. The seller provides services or products as the agreement. The data processing center also generates a password with a “buyer unit” link to buyer, where the buyer can confirm the receiving of services or products.

The services or products are shipped to buyers address. The buyer should confirm the shipment at the “buyer unit” by login in the buyer unit with password, or if the buyer does not confirm this shipment within certain time, the money will be released to seller, and the buyer will not get the money back.

In one embodiment, if the buyer is not happy with the services or products, the buyer should login the “buyer unit” to complaint. The system will send this information to seller, and keep holding the money until the seller confirm that he gets the returned services/products. If the seller does not confirm within certain time, system automatically confirms that seller gets the returned service/products. The money will return to buyer after certain fees to system.

In another embodiment, if the buyer does not get the services/products, which is claimed on the “buyer unit”, the information will automatically send to the seller. The seller should login in the seller unit within the time frame. If the seller does ship out the services/products, a track number should be provided in seller unit, which allows the data processing unit automatically to track the delivery status. Since almost all shipping company provides track service online, there are no problems for the data processing unit to check delivery status. All the information will be send to buyers and the time frame extend. Otherwise, the money will return to buyer.

When the business transaction is over, the system will send a message to ask money wire instruction. The money will be delivered to the right person by the payment system by bank wiring, credit card credit, cash or any other possible methods.

The said payment system can embedded into other commercial web site, working as an online payment system. The payment system may work independently as an online letter of credit, providing a service of guaranty for business transaction.

What is claimed is:

1. A method of online third party payment system, wherein the system is in the middle of business transaction as a guarantor.

2. A method as claim in claim 1, wherein the system comprises of online payment processing unit, buyer unit, data processing center, and seller unit;

3. A method as claim in claim 2, wherein the step of a successful money and business transaction comprises of the steps of:
Transmitting the data of buyer payment information, both party email and other contact information, shipping time frame from buyer unit to data processing center, after buyer or both parties input all information at the system web site;
Verifying payment information by the online payment processing unit and sending all data to data processing center;
Holding the money of buyers;
Generating a password and seller unit web link to seller through email by data processing center, and informing seller that the money is ready and seller should provide service/products;
Generating a password and buyer unit web link to buyer through email by data processing center;
Confirming the business transaction is fulfilled by buyer at the buyer unit after buyer logins in buyer unit with password, or automatically confirming the business transaction is fulfilled if the buyer does not response beyond certain time after the services/products are provided;
Releasing money to the seller;

4. A method as claim in claim 3, when the quality of services/products is in question, wherein the step of complaint process comprises of the steps of:
Complaining the services/products in the buyer unit by the buyer, and returning the services/products;
Transmitting above information to the data processing center, where the data are analyzed and sent to the seller;
Verifying the services/products are returned by the seller, or automatically confirming the service/products returned if seller does not confirm at the seller unit within certain time;
Releasing money to seller if seller confirms the services/products are not returned;
Releasing money to buyer if services/products returned;

5. A method as claim in claim 3, when buyer does not received service/products, wherein the step of complaint further comprises of the steps of:
Complaining services/products are not received by buyer at the buyer unit after buyer logins in buyer unit with password;
Transmitting above information to data processing center, and sending the data to the seller;
Proving track number by seller at the seller unit;
Transmitting this information to data processing center as well as to buyer;
Tracking the delivery status by data processing center through the post office gateway;
Extending the delivery time, and continuing the steps of claim 3 until the transaction fulfilled if the delivery is performed;
Refunding money to buyer if delivery is not performed;

6. A method of money releasing, when the business transaction is over, comprising the steps of:
Asking money wire instruction by data processing center through sell unit or buyer unit;
Delivering money to the right person according to instruction;
